(19) United States
(12) Patent Application Publication
(10) Pub. No.: US 2024/0279933 A1
(43) Pub. Date: Aug. 22, 2024

(54) VEHICLE CONTROL DEVICE FOR DRIVER AND VEHICLE CONTROL METHOD FOR DRIVER

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/651,774

(22) Filed: May 1, 2024

Related U.S. Application Data
(63) Continuation of application No. 10/212,022, filed on Aug. 5, 2002, now abandoned.

(30) Foreign Application Priority Data
Nov. 3, 2021 (JP) 2021-179898
Oct. 21, 2022 (JP) 2022-169376

(51) Int. Cl. E04D 13/076

(52) U.S. Cl. CPC E04D 13/0765

(57) ABSTRACT

A vehicle control device for driver is configured to: acquire currently executing autonomous driving level and scheduled autonomous driving level; acquire a consciousness state of driver; in response to the autonomous driving level is required to be switched to a level lower than a nap enabled autonomous driving level in reclined state of driver seat back, terminate the reclined state and output a notification notifying termination of the reclined state. The vehicle control device further acquires a destination type, determines an execution order of an angle control of the driver seat back and an output control of the notification according to the consciousness state of driver, and changes details of the angle control of the driver seat back when the destination is set to a boarding and alighting area from when the destination is set to a parking lot.

### CROSS REFERENCE TO RELATED APPLICATIONS

The present application is a continuation application of International Patent Application No. PCT/JP2022/040231 filed on Oct. 27, 2022, which designated the U.S. and claims the benefits of priorities from Japanese Patent Application No. 2021-179890 filed on Nov. 3, 2021, and Japanese Patent Application No. 2022-169376 filed on Oct. 21, 2022. The entire disclosures of all of the above applications are incorporated herein by reference.

### TECHNICAL FIELD

The present disclosure relates to a vehicle control device for driver and a vehicle control method for driver.

### BACKGROUND

Conventionally, in vehicles equipped with autonomous driving systems, reclining of the driver seat is permissible during execution of autonomous driving control.

### SUMMARY

The present disclosure provides a vehicle control device for driver. The vehicle control device for driver is configured to: acquire a currently executing autonomous driving level and a scheduled autonomous driving level; acquire a consciousness state of driver; in response to the autonomous driving level is required to be switched to a level lower than a nap enabled autonomous driving level in reclined state of driver seat back, terminate the reclined state and output a notification notifying termination of the reclined state. The vehicle control device further acquires a destination type, determines an execution order of an angle control of the driver seat back and an output control of the notification according to the consciousness state of driver, and changes details of the angle control of the driver seat back when the destination is set to a boarding and alighting area from when the destination is set to a parking lot.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of vehicle equipped with a vehicle control device for driver according to a first embodiment of the present disclosure;

FIG. 2 is a block diagram showing functions of the autonomous driving ECU;

FIG. 3 is a flowchart showing a process executed by a reclining control unit;

FIG. 4 is a flowchart showing a process executed by the reclining control unit subsequent to the process shown in FIG. 3;

FIG. 5 is a flowchart showing a process executed by an autonomous driving control execution unit and a reclining control unit according to a second embodiment of the present disclosure;

FIG. 6 is a flowchart showing processing executed by a reclining control unit according to a third embodiment of the present disclosure;

FIG. 7 is a flowchart showing another process executed by the reclining control unit;

FIG. 8 is a diagram showing a process executed by a reclining control unit subsequent to the process shown in FIG. 3 according to a fourth embodiment of the present disclosure;

FIG. 9 is a block diagram showing functions of an autonomous driving ECU according to a fifth embodiment of the present disclosure;

FIG. 10 is flowchart showing a process executed by a wiper control unit; and

FIG. 11 is a flowchart showing another process executed by the wiper control unit.

### DETAILED DESCRIPTION

Generally, in a vehicle, when the driver seat is reclined, the driver can take a nap on the driver seat. A reclined state is a state in which an angle of seat back has a reclined angle. The reclined angle is an angle that is more inclined toward rear direction of the vehicle than a proper driving state angle set during a driving state. Hereinafter, an autonomous driving level at which the driver can take a nap is also referred to as a nap enabled autonomous driving level.

It is not required for the autonomous driving system to maintain the nap enabled autonomous driving level during execution of autonomous driving. An operational design domain (ODD) is set for executing the autonomous driving. An autonomous driving system performs autonomous driving control at a nap enabled autonomous driving level when the corresponding ODD is satisfied.

When the ODD is no longer satisfied, the autonomous driving system changes the autonomous driving level from the nap enabled autonomous driving level to an autonomous driving level in which the driver is required to be able to immediately take over driving operation or a further lower autonomous driving level.

The nap enabled autonomous driving level corresponds to level 4 of autonomous driving, and the autonomous driving level that requires the driver to immediately take over the driving operation corresponds to level 3 of autonomous driving. When the ODD is no longer satisfied, the autonomous driving system switches the autonomous driving level from level 4 to level 3 or lower.

When switching the autonomous driving level to level 3 or lower, if the driver is in a nap state, it is necessary to wake up the driver. At the autonomous driving level 4, it is possible to recline a back of driver seat even while the vehicle is in traveling state. At the autonomous driving level 3 or lower, reclined state of the back of driver seat is not proper. Therefore, it is proper to terminate the reclined state of the back of driver seat.

In response to the autonomous driving level changing to a level lower than the nap enabled autonomous driving level, if the same control is executed to terminate the reclined state regardless of whether the driver's conscious state is awake or asleep, it may be difficult for the driver to quickly adapt to the autonomous driving level which is changed to the lower level.

According to an aspect of the present disclosure, a vehicle control device for driver is used in a vehicle. The vehicle is equipped with: an autonomous driving system capable of switching autonomous driving between a nap enabled autonomous driving level, which enables a driver to take a nap, and an autonomous driving level, which requires the driver to immediately get prepared for takeover of driving operation, or lower; a driver seat angle adjustment unit adjusting an angle of a driver seat back; and a driver condition determination unit determining whether a consciousness state of the driver is an awake state or a sleep state. The vehicle control device for driver includes: an autonomous driving level acquisition unit acquiring a currently executing autonomous driving level that is currently being executed by the autonomous driving system and a scheduled autonomous driving level that is scheduled to be executed; a driver condition acquisition unit acquiring the consciousness state of the driver from the driver condition determination unit; and a reclining control unit, in response to the autonomous driving level acquisition unit acquiring that the autonomous driving level is to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle. The autonomous driving level acquisition unit acquires a type of a destination when the vehicle can reach the destination with the nap enabled autonomous driving level being maintained. The type of the destination includes at least one of (i) a boarding and alighting area or (ii) a parking lot. In the termination of the reclined state, the reclining control unit determines, according to the consciousness state of the driver, an execution order of an angle control, which controls the angle of the driver seat back to terminate the reclined state, and an output control, which outputs the notification related to the termination of the reclined state. The reclining control unit changes details of the angle control, which controls the angle of the driver seat back to terminate the reclined state, when the destination is set to the boarding and alighting area from when the destination is set to the parking lot.

According to another aspect of the present disclosure, a vehicle control method for driver includes: acquiring a currently executing autonomous driving level at which the autonomous driving system is executing the autonomous driving and the autonomous driving level scheduled to be executed; acquiring the consciousness state of the driver from the driver condition determination unit; in response to acquiring that the autonomous driving level is required to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle; acquiring a type of a destination when the vehicle can reach the destination with the nap enabled autonomous driving level being maintained, the type of the destination including at least one of (i) a boarding and alighting area or (ii) a parking lot; determining, according to the consciousness state of the driver, an execution order of an angle control, which controls the angle of the driver seat back to terminate the reclined state, and an output control, which outputs the notification related to the termination of the reclined state; and changing details of the angle control, which controls the angle of the driver seat back to terminate the reclined state, when the destination is set to the boarding and alighting area from when the destination is set to the parking lot.

According to the above vehicle control device for driver and the vehicle control method for driver, when the driver seat back is in the reclined state and the autonomous driving level is required to be switched to an autonomous driving level lower than the nap enabled autonomous driving level, the reclined state is terminated. In addition, the notification associated with termination of the reclined state is output from the notification unit. By outputting the notification associated with the termination of reclined state, it is possible to prevent the driver from feeling uncomfortable due to the automatic termination of reclined state.

When terminating the reclined state, instead of controlling the angle of driver seat back and the output control from the notification unit in one fixed pattern, execution order of the angle control for terminating the reclined state of the driver seat back and output control for outputting the notification from the notification unit is properly determined according to the consciousness state of the driver. This configuration enables the driver to adapt to the autonomous driving level which has been switched to a lower level, and the convenience of nap enabled autonomous driving can be ensured.

According to another aspect of the present disclosure, a vehicle control device for driver is used in a vehicle. The vehicle is equipped with: an autonomous driving system capable of switching autonomous driving between a nap enabled autonomous driving level, which enables a driver to take a nap, and an autonomous driving level, which requires the driver to immediately get prepared for takeover of driving operation, or lower; a driver seat angle adjustment unit adjusting an angle of a driver seat back; and a driver condition determination unit determining whether a consciousness state of the driver is an awake state or a sleep state. The vehicle control device for driver includes: an autonomous driving level acquisition unit acquiring a currently executing autonomous driving level that is currently being executed by the autonomous driving system and a scheduled autonomous driving level that is scheduled to be executed; a driver condition acquisition unit acquiring the consciousness state of the driver from the driver condition determination unit; and a reclining control unit terminating a reclined state of the driver seat back in response to the autonomous driving level acquisition unit acquiring that the autonomous driving level is to be switched from the nap enabled autonomous driving level to the autonomous driving level lower than the nap enabled autonomous driving level in the reclined state of the driver seat back. In termination of the reclined state of the driver seat back, the reclining control unit determines different maximum control angles of the driver seat back according to different consciousness states of the driver, and sets the angle of the driver seat back to a forward inclined angle when the consciousness state of the driver is the sleep state.

According to another aspect of the present disclosure, a vehicle control method for driver includes: acquiring a currently executing autonomous driving level at which the autonomous driving system is executing the autonomous driving and the autonomous driving level scheduled to be executed; acquiring the consciousness state of the driver from the driver condition determination unit; terminating a reclined state of the driver seat back in response to acquiring that the autonomous driving level is to be switched from the nap enabled autonomous driving level to the autonomous driving level lower than the nap enabled autonomous driving level in the reclined state of the driver seat back; and determining different maximum control angles of the driver seat back according to different consciousness states of the driver and setting the angle of the driver seat back to a forward inclined angle when the consciousness state of the driver is the sleep state in terminating of the reclined state of the driver seat back.

According to the above vehicle control device for driver and the vehicle control method for driver, when the driver seat back is in the reclined state and the autonomous driving level is switched from the nap enabled autonomous driving level to the autonomous driving level lower than the nap enabled autonomous driving level, the reclined state is terminated. When terminating the reclined state, the maximum control angle of the driver seat back is changed depending on the consciousness state of driver. By changing the maximum control angle of the driver seat back depending on the consciousness state of driver, the driver can quickly adapt to the autonomous driving level that has been changed, regardless of the consciousness state of driver. Thus, it is possible to ensure the convenience of nap enabled autonomous driving.

According to another aspect of the present disclosure, a vehicle control method for driver is used in a vehicle. The vehicle is equipped with: an autonomous driving system capable of performing autonomous driving at a nap enabled autonomous driving level that enables a driver to take a nap; a driver seat angle adjustment unit adjusting an angle of a driver seat back; and a driver condition determination unit determining whether a consciousness state of the driver is an awake state or a sleep state. The vehicle control device for driver includes: a driver condition acquisition unit acquiring the consciousness state of the driver from the driver condition determination unit; and a reclining control unit controlling a reclined state of the driver seat back. When the vehicle approaches a destination with the nap enabled autonomous driving level being maintained, the reclining control unit executes an angle control of the driver seat back, which terminates the reclined state, in response that the consciousness state of the driver is the awake state. When the vehicle approaches the destination with the nap enabled autonomous driving level being maintained, the reclining control unit suspends the angle control of the driver seat back, which terminates the reclined state, in response that the consciousness state of the driver is the sleep state.

According to another aspect of the present disclosure, a vehicle control method for driver includes: acquiring the consciousness state of the driver from the driver condition determination unit; when the vehicle approaches a destination with the nap enabled autonomous driving level being maintained, executing an angle control of the driver seat back, which terminates a reclined state of the driver seat back, in response that the consciousness state of the driver is the awake state; and when the vehicle approaches the destination with the nap enabled autonomous driving level being maintained, suspending the angle control of the driver seat back, which terminates the reclined state of the driver seat back, in response that the consciousness state of the driver is the sleep state.

According to the above vehicle control device for driver and vehicle control method for driver, even when the vehicle approaches the destination with the driver seat back in reclined state, the termination of the reclined state is suspended according to the consciousness state of the driver. Therefore, the driver can maintain the sleep state. According to this configuration, the convenience of nap enabled autonomous driving can be ensured.

The following will describe embodiments of the present disclosure with reference to accompanying drawings. It is noted that the same reference symbols are attached to the corresponding constituent elements in each embodiment, and redundant explanation may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the multiple embodiments can be partially combined even if they are not explicitly shown if there is no problem in the combinations in particular.

### First Embodiment

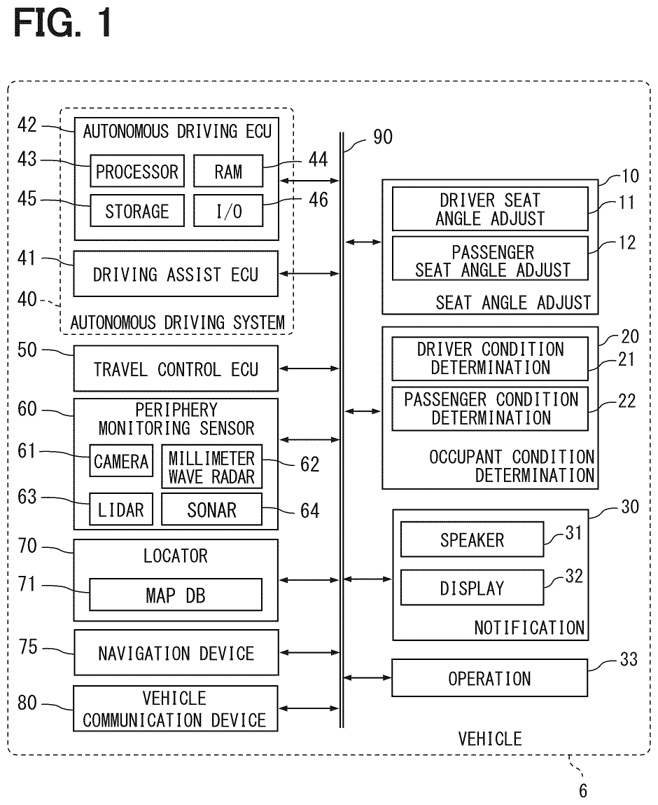

The vehicle 6 shown in FIG. 1 is equipped with an autonomous driving system 40. The vehicle 6 is equipped with a driver seat. An occupant sitting in the driver seat can drive the vehicle 6 as a driver. The vehicle 6 is capable of performing autonomous driving such that the vehicle autonomously travels without any driving operation made by the driver. The vehicle 6 also includes a passenger seat where an occupant other than the driver is seated as a passenger. The vehicle 6 is equipped with the driver seat, one or more passenger seats, configurations shown in FIG. 1. The vehicle 6 travels on a road.

An angle of a back of at least one of the driver seat and the passenger seats can be changed. The back of seat is a portion that supports an upper body of occupant. In some cases, the back of seat is referred to as a backrest. A seat angle adjustment unit 10 adjusts the angle of back of seat. The seat angle adjustment unit 10 includes a driver seat angle adjustment unit 11 and a passenger seat angle adjustment unit 12.

The driver seat angle adjustment unit 11 adjusts the angle of back of driver seat (hereinafter referred to as the driver seat back). The driver seat angle adjustment unit 11 includes a gear, which rotates to change the angle of driver seat back, and a motor, which rotates the gear. In addition to the gear and the motor, the driver seat angle adjustment unit 11 includes an angle sensor that detects the angle of driver seat back, a motor control circuit that controls the motor to a desired angle based on the angle detected by the angle sensor, and the like. A rotational speed of the motor can be changed at multiple levels (for example, two levels), and the driver seat angle adjustment unit 11 can change the angle of driver seat back at multiple types of speeds.

The passenger seat angle adjustment unit 12 adjusts the angle of back of passenger seat (hereinafter referred to as passenger seat back). Similar to the driver seat angle adjustment unit 11, the passenger seat angle adjustment unit 12 includes a gear, a motor, an angle sensor, a motor control circuit, and the like. Similar to the driver seat angle adjustment unit 11, the passenger seat angle adjustment unit 12 can change the angle of passenger seat back at multiple speeds.

The vehicle 6 also includes an occupant condition determination unit 20, a notification unit 30, an operation unit 33, an autonomous driving system 40, a travel control ECU 50, a periphery monitoring sensor 60, a locator 70, a navigation device 75, a vehicle communication device 80, and the like. A communication bus 90 is provided to communicably connect these components.

The occupant condition determination unit 20 includes a driver condition determination unit 21 and a passenger condition determination unit 22. The driver condition determination unit 21 successively determines a condition of the driver. The driver condition determination unit 21 may include a near-infrared light source, a near-infrared camera, and a control unit that controls the near-infrared light source and the near-infrared camera. The driver condition determination unit 21 may be arranged on the top surface of steering column, on the top surface of instrument panel, with the near-infrared camera directed toward a headrest portion of the driver seat. The driver condition determination unit 21 uses the near-infrared camera to capture an image of the driver's head, which is irradiated with near-infrared light emitted from the near-infrared light source. The image captured by the near-infrared camera is analyzed by the control unit. The control unit successively determines whether the driver's consciousness state is awake or asleep based on the analysis result of image. Note that a sleep state includes a state in which the driver feels drowsiness to a degree that is not suitable for performing driving operation.

The passenger condition determination unit 22 successively determines whether the consciousness state of passenger is awake or asleep. In addition, the passenger condition determination unit 22 also determines whether the passenger is an infant. For example, the passenger condition determination unit 22 determines whether the passenger is an infant by analyzing an image of passenger's appearance captured by a camera.

The notification unit 30 provides various notifications to the driver and passenger. The notification unit 30 includes a speaker 31 and a display 32. The speaker 31 outputs sound toward a compartment of the vehicle 6. As the display 32, one or more display units may be provided. At least one display 32 is arranged at a position visible to the driver. For example, one display 32 is a center information display (hereinafter referred to as CID) arranged on an instrument panel.

The operation unit 33 is an interface that receives user operation made by the driver, the passenger, or the like. The operation unit 33 receives user operations related to activation and deactivation of the autonomous driving function, user operations for inputting a destination into the navigation device 75, and the like. The operation unit 33 includes a steering switch arranged on the spoke of steering wheel, a touch panel arranged integrally with the display 32, a voice input device for recognizing the contents of the occupant's speech, and the like.

The autonomous driving system 40 is a system that can perform autonomous driving at different autonomous driving levels. Hereinafter, autonomous driving level is also referred to as AD level or level for simplification. When one of the different autonomous driving levels satisfies ODD, the driver has no periphery monitoring obligation. When the autonomous driving is performed in this level, the driver can take a nap. This level of autonomous driving is defined as the nap enabled autonomous driving level. In order to simplify the description, hereinafter this level of autonomous driving is also referred to as autonomous driving level 4. ODD can be set in various manners. One or more of road conditions, geographical conditions, environmental conditions, and other conditions may be set in the ODD. An example of ODD, the road type is limited to highway. As another example of ODD, the weather condition may be other than heavy rain or snowfall.

The autonomous driving system 40 can also execute autonomous driving control at an autonomous driving level lower than autonomous driving level 4, that is, autonomous driving level 3 or lower. At autonomous driving level 3, the autonomous driving system 40 automatically causes the vehicle 6 to travel within the ODD set for autonomous driving level 3, and the driver has no obligation to monitor periphery area of the vehicle. In the autonomous driving level 3, the driver is required to be able to take over driving operation immediately. At the autonomous driving level 2, the autonomous driving system 40 requires the driver to mainly perform driving operation of vehicle 6, and the autonomous driving system 40 provides driving assist to the driver. In the autonomous driving level 2, the driver has obligation to monitor the periphery area of vehicle.

The autonomous driving system 40 includes a driving assist ECU 41 and an autonomous driving ECU 42.

The driving assist ECU 41 is an electronic control unit (ECU) that successively determines vehicle control when the autonomous driving system 40 executes autonomous driving level 2 that performs driving assist. The autonomous driving ECU 42 is an ECU that successively determines vehicle control when the autonomous driving system 40 executes the autonomous driving at a level that does not require monitoring obligation for the driver.

The autonomous driving ECU 42 is implemented by a computer including a processor 43, a RAM 44, a storage 45, an input output interface (I/O) 46, a bus connecting these components. The driving assist ECU 41 is also implemented by a computer including a processor, a RAM, a storage, an input output interface, a bus connecting these components.

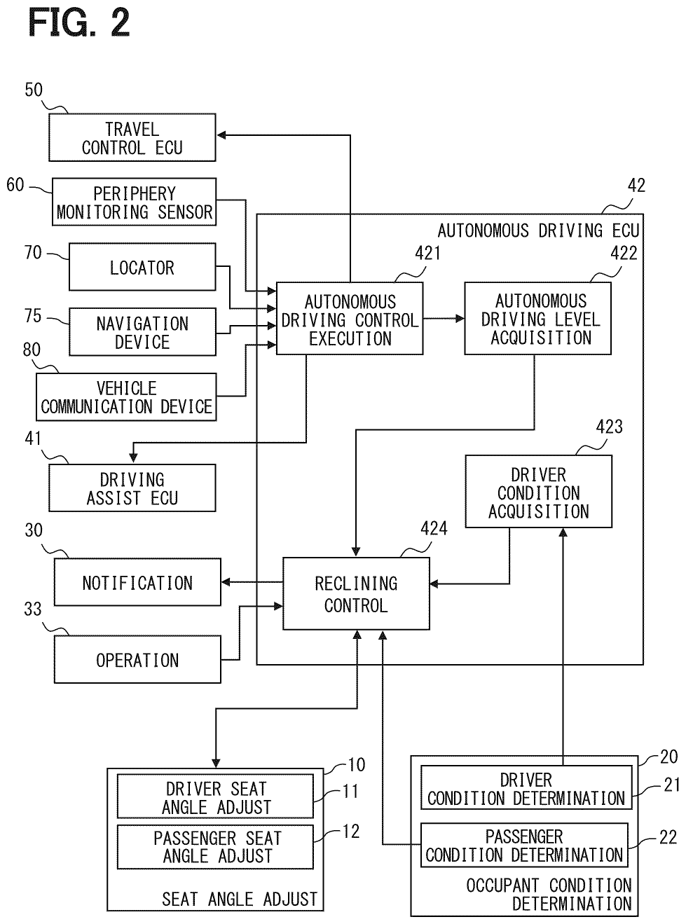

The processor 43 includes at least one processor. The processor 43 accesses the RAM 44 to execute various processes for performing the vehicle control method for driver according to the present disclosure. The storage 45 stores various programs (such as vehicle control method program for driver) to be executed by the processor 43. By executing the program with the processor 43, the autonomous driving ECU 42 performs the function of each functional unit shown in FIG. 2. Details of FIG. 2 will be described later.

The travel control ECU 50 is implemented by an electronic control unit mainly including a microcontroller. The travel control ECU 50 has at least functions of a brake control ECU, a drive control ECU, and a steering control ECU. The travel control ECU 50 controls a brake force of each wheel, controls an output of vehicle-mounted power source, and controls a steering wheel angle, based on one of an operation command corresponding to the driving operation made by driver, a control command from the driving assist ECU 41, and a control command from the autonomous driving ECU 42. The travel control ECU 50 generates vehicle speed information indicating a current travel speed of the vehicle 6 based on a detection signal of wheel speed sensor arranged at a hub portion of each wheel, and successively outputs the generated vehicle speed information to the communication bus 90.

The periphery monitoring sensor 60 is an autonomous sensor that monitors a periphery environment of the vehicle 6. The periphery monitoring sensor 60 can detect moving objects and stationary objects within a detection range defined around the vehicle. The periphery monitoring sensor 60 is capable of detecting at least a proceeding vehicle, a following vehicle, or a lateral side vehicle, which travels around the vehicle 6. The periphery monitoring sensor 60 provides detection information of objects existing around own vehicle to the driving assist ECU 41, the autonomous driving ECU 42, and the like.

The periphery monitoring sensor 60 may include at least one of a camera unit 61, a millimeter wave radar 62, a lidar 63, or a sonar 64. The camera unit 61 is mounted on the vehicle 6 and captures images of front area of the vehicle 6. The millimeter wave radar 62 radiates millimeter waves or quasi-millimeter waves toward a periphery area of own vehicle. The millimeter wave radar 62 outputs detection information generated by processing waves reflected by a moving object, a stationary object, or the like. The lidar 63 emits laser light toward a periphery area of own vehicle. The lidar 63 outputs detection information generated by processing received laser light reflected by a moving object, a stationary object, or the like existing in an irradiation range. The sonar 64 emits ultrasonic wave toward a periphery area of own vehicle. The sonar 64 outputs detection information generated by processing received ultrasonic wave reflected by a moving object, a stationary object, or the like existing near the subject vehicle.

The locator 70 includes a global navigation satellite system (GNSS) receiver, an inertial sensor, and the like. The locator 70 combines positioning signals received by the GNSS receiver, measurement results of the inertial sensor, the vehicle speed information outputted to the communication bus 90, and successively determines the current position and traveling direction of the vehicle 6. The locator 70 successively outputs, to the communication bus 90, the location information and the direction information of the vehicle 6, which is acquired based on the positioning result, as locator information.

The locator 70 further includes a map database (hereinafter, referred to as map DB) 71 that stores map data. The map DB 71 mainly includes a large capacity storage medium for storing a large number of three-dimensional map data records and two-dimensional map data records. The three-dimensional map data is also known as high definition (HD) map, and includes road information necessary for the autonomous driving control. The three-dimensional map data includes information necessary for advanced driving support and autonomous driving, such as three-dimensional shape information of roads and detailed information on each lane. The locator 70 reads out map data around the current position of own vehicle from the map DB 71, and provides the read-out map data to the driving assist ECU 41, autonomous driving ECU 42, together with the locator information.

The navigation device 75 acquires information on a destination set by an occupant, such as a driver based on operation information of user operation. The navigation device 75 uses the locator information acquired from the locator 70 to set a route from the current position to the destination. The navigation device 75 displays a guide image for route guidance on the display 32 provided as the CID. The navigation device 75 provides the autonomous driving system 40 with destination information indicating the destination and route information indicating a set route to the destination.

The vehicle communication device 80 is an external communication unit mounted on the vehicle 6 and functions as a V2X (Vehicle to Everything) communication device. The vehicle communication device 80 transmits and receives information by wireless communication to and from a roadside device provided along the road. As an example, the vehicle communication device 80 receives, from the roadside device, traffic congestion information around the current position of the vehicle 6 and travel direction of own vehicle. The vehicle communication device 80 provides the received congestion information to the autonomous driving ECU 42 and the like.

### (Functions Executed by Autonomous Driving ECU 42)

FIG. 2 shows functions executed by the autonomous driving ECU 42. The autonomous driving ECU 42 includes, as functional blocks, an autonomous driving control execution unit 421, an autonomous driving level acquisition unit 422, a driver condition acquisition unit 423, and a reclining control unit 424, by executing the program using the processor 43. The autonomous driving ECU 42 implements the vehicle control device for driver by including the autonomous driving level acquisition unit 422, the driver condition acquisition unit 423, and the reclining control unit 424, as functional blocks.

The autonomous driving control execution unit 421 recognizes a travel environment required for executing the autonomous driving by combining detection information acquired from the periphery monitoring sensor 60, the locator information and map data acquired from the locator 70, and the traffic congestion information acquired from the vehicle communication device 80. The autonomous driving control execution unit 421 successively determines the current autonomous driving level based on the recognized travel environment and ODD. When a destination is set in the navigation device 75, the autonomous driving control execution unit 421 enables execution of autonomous driving level that does not require periphery monitoring obligation. When the determined autonomous driving level is an autonomous driving level that does not require periphery monitoring obligation, the autonomous driving control execution unit 421 issues a control command for executing vehicle control to automatically drive the vehicle 6 based on the recognized travel environment, and successively outputs the control command to the travel control ECU 50. When the determined autonomous driving level is a level corresponding to driving assist, the autonomous driving control execution unit 421 instructs the driving assist ECU 41 to control the vehicle.

The autonomous driving control execution unit 421 determines not only the currently executing autonomous driving level but also determines a scheduled autonomous driving level. The currently executing autonomous driving level indicates the autonomous driving level required to keep the vehicle 6 traveling in accordance with the traffic flow. The currently executing autonomous driving level is also referred to as a currently executing dynamic driving level. The currently executing autonomous driving level is, for example, the autonomous driving level to be executed up to several seconds from the current time.

The scheduled autonomous driving level is an autonomous driving level to be executed at a point after the currently executing autonomous driving level. For example, suppose a case where ODD of the autonomous driving level 4 is limited to highway, and the vehicle 6 is scheduled to enter a general road after traveling a distance of 10 km. In the present disclosure, a local road indicates a road other than highway. In this case, the autonomous driving control execution unit 421 determines to end the autonomous driving level 4 after traveling 10 km and switch to a lower autonomous driving level, for example, autonomous driving level 2.

The autonomous driving level acquisition unit 422 successively acquires the autonomous driving level successively determined by the autonomous driving control execution unit 421. When the autonomous driving control execution unit 421 has determined the scheduled autonomous driving level that is scheduled to be executed, the autonomous driving level acquisition unit 422 acquires the scheduled autonomous driving level and the time to execute scheduled the autonomous driving level.

The driver condition acquisition unit 423 successively acquires the driver's state of consciousness, which is successively determined by the driver condition determination unit 21. As described above, the driver's consciousness state indicates whether the driver is in awake state or asleep state.

The reclining control unit 424 successively acquires the currently executing autonomous driving level and the scheduled autonomous driving level, from the autonomous driving level acquisition unit 422. The driver condition acquisition unit 423 successively acquires the driver's condition. The reclining control unit 424 successively acquires the condition of passenger from the passenger condition determination unit 22. The condition of passenger includes a state of consciousness of passenger and whether or not the passenger is an infant. The reclining control unit 424 also acquires the angles of the driver seat back and the passenger seat back, from the seat angle adjustment unit 10. The reclining control unit 424 controls the angles (reclined state) of driver seat back and passenger seat back, based on the acquired information.

The following will describe a control executed by the reclining control unit 424. When the driver seat back is in a reclined state and the autonomous driving level acquisition unit 422 acquires that the autonomous driving level will be switched to a level lower than the autonomous driving level 4, the reclining control unit 424 performs an angle control to terminate reclined state. The notification unit 30 performs an output control to output a notification associated with termination of the reclined state. The reclining control unit 424 determine may properly determine an execution order of the angle control and the output control according to the consciousness state of driver. The maximum standing angle of driver seat back when terminating the reclined state may be changed according to the consciousness state of driver.

The reclined state refers to a state in which the back of driver seat is reclined more toward a rear direction of the vehicle compared with a proper angle set during driving operation. The specific reclined angle may be set as appropriate. For example, the angle of driver seat back set when the vehicle 6 is traveling at an autonomous driving level 2 or lower may correspond to a driving state angle. When the angle of driver seat back is reclined toward the rear direction of vehicle by a certain angle (for example, 10 degrees) or more than the driving state angle, this state may be referred to as the reclined state. The reclined state of passenger seat back indicates a state in which the back of passenger seat is reclined toward the rear direction of vehicle beyond the angle at which the seat belt can fully execute the function. The angle of passenger seat back that allows the seat belt to fully execute its function corresponds to a standard angle. The specific angle range within which the back of passenger seat is reclined may be set same as the angle range within which the back of driver seat is reclined.

### (Detailed Control Executed by Reclining Control Unit 424)

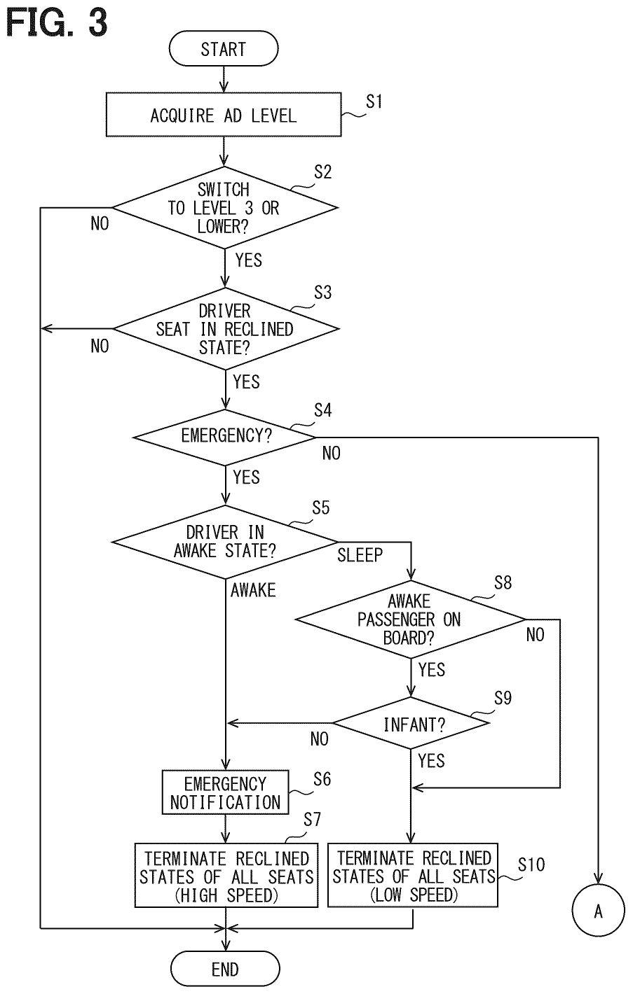

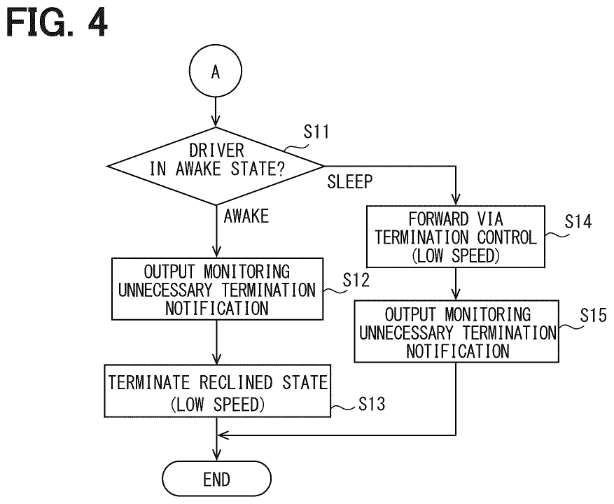

The control executed by the reclining control unit 424 will be explained in detail using FIG. 3 and FIG. 4. The reclining control unit 424 successively executes the process shown in FIG. 3 when the autonomous driving control execution unit 421 starts the autonomous driving at autonomous driving level 4 or higher. Note that in FIG. 3 and FIG. 4, the reclining control unit 424 executes processes other than S1, S5, and S11. S1 is executed by the autonomous driving level acquisition unit 422. S5 and S11 are executed by the driver condition acquisition unit 423.

In S1, the driver condition acquisition unit 423 acquires the currently executing autonomous driving level executed by the autonomous driving control execution unit 421 and the scheduled autonomous driving level. The autonomous driving level is also referred to as AD level.

In S2, the process determines whether the autonomous driving level is to be switched to level 3 or lower based on the information acquired in S1. When the process determines NO in S2, the process of FIG. 3 is ended. When the process determines YES in S2, the process proceeds to S3.

In S3, the angle of driver seat back is acquired from the driver seat angle adjustment unit 11, and the process determines whether the driver seat is in a reclined state. When the process determines NO in S3, the process of FIG. 3 is ended. When the process determines YES in S3, the process proceeds to S4.

In S4, the process determines whether it is emergent to switch the autonomous driving level. In S2, when the currently executing autonomous driving level is determined to be changed, that is, the currently executing autonomous driving level is determined to be immediately changed to level 3 or lower, the process determines YES in S4. When the vehicle unexpectedly fails to satisfy ODD due to weather change or the like, there is a possibility that the autonomous driving level will be changed immediately. In S2, when the switch of autonomous driving level is determined within a predetermined period, the process determines NO in S4. For example, when the vehicle 6 is scheduled to enter the local road after traveling 10 km of highway, the switch of autonomous driving level is determined. When the determination result in S4 is YES, the process proceeds to S5.

In S5, the process determines whether the driver is in awake state. When the driver is determined to awake, the process proceeds to S6. In S6, the notification unit 30 outputs an emergency notification indicating that the autonomous driving level is to be switched emergently. Note that when the driver back seat is in the reclined state, the notification may be made using a notification sound. This is because the driver is difficult to view the display 32 in the reclined state of the driver seat. As another example, the notification may be made using sound and display.

After outputting the emergency notification in S6, the reclined states of all the seats in the reclined states are terminated in S7. In S7, the change speed of the angle of seat back when terminating the reclined state is set to be high. The specific speed may be set to the highest speed within a permissible speed range when the occupant is seated. For the driver seat, the angle of seat back after the reclined state is terminated is set to the driving state angle. For the passenger seat, the angle of seat back after the reclined state is terminated is set to the standard angle.

When the process determines in S5 that the driver is in a sleep state, the process proceeds to S8. In S8 and S9, sequential control condition is determined. When the sequential control condition in S8 and S9 is satisfied, the process proceeds to S6 and the control is executed successively in the order of emergency notification and then termination of reclining, even though the driver is in a sleep state. In S8, the process determines whether a passenger in awake state is on board. When the process determines YES in S8, the process proceeds to S9.

In S9, the process determines whether the only passenger who is awake is an infant. When the process determines NO in S9, that is, there is an awake passenger who is not an infant, the control conditions in S8 and S9 are determined to be satisfied, and the process proceeds to S6. IN S9, when the only passenger in the awake state is an infant, the process proceeds to S10. When the process determines NO in S8, the process proceeds to S10.

In S10, the reclined states of all the seats in the reclined states are terminated. In S10, the change speed of the angle of seat back when terminating the reclined state is set to be high rate. For the driver seat, the angle of seat back after the reclined state is terminated is set to the driving state angle. For the passenger seat, the angle of seat back after the reclined state is terminated is set to the standard angle. In S10, simultaneously with the angle control to terminate the reclined state, the notification unit 30 outputs an emergency notification indicating that the autonomous driving level will be switched emergently. That is, S6 and S7 are simultaneously executed in S10. Simultaneous does not necessarily have to be simultaneous in a strict meaning. A time difference within a range that the awake passenger feels simultaneous may be acceptable. After execution of S6 and before execution of S7, the awake passenger needs a period of time to recognize the emergency notification and understand the meaning of emergency notification.

The following will describe the process executed when the determination result in S4 is NO. When the determination result in S4 is NO, the process proceeds to S11 shown in FIG. 4.

In S11, similarly to S5, the process determines whether the driver is in awake state. When the driver is in awake state, the process proceeds to S12.

In S12, the notification unit 30 outputs a monitoring unnecessary termination notification. The monitoring unnecessary termination notification directly or indirectly indicates a coming termination of autonomous driving level 4, which is an autonomous driving level that does not require monitoring obligation by driver. An example of the indirect notification may correspond to a notification that notifies the autonomous driving level after switch. The notification unit may notify when the autonomous driving level will be switched.

In S13, the reclined state of driver seat back is terminated. In S7, the change speed of the angle of driver seat back when terminating the reclined state is set to be low rate. The change speed of the angle of seat back in S13 is lower than the change speed of the angle of seat back in S7. The change speed of the angle of seat back in S13 is the change speed set at the operation time by the occupant.

When the process determines in S11 that the driver is in a sleep state, the process proceeds to S14. In S14, the reclined state of the driver seat back is terminated by a forward via termination control. The forward via termination control is a control in which the seat back is first set to a forward angle and then set to the driving state angle. The forward angle is set to be inclined more toward the front direction of vehicle compared with the driving state angle. Therefore, the forward angle includes the vertical direction. In forward via termination control, the angle at which the seat back is inclined toward the front of vehicle may be set in advance. For example, the back of driver seat is inclined at an angle of 20 degrees toward the front of vehicle from the vertical direction.

When terminating the reclined state, the angle at which the back of driver seat is closest to the front of vehicle is defined as the maximum control angle. The maximum control angle in S14 is the forward angle described above. The maximum control angle of driver seat back in S7, S10, and S13 is the driving state angle.

Similar to S12, the process controls the notification unit 30 to output a monitoring unnecessary termination notification in S15. The notification unit may notify when the autonomous driving level will be switched.

The reclining control unit 424 executes angle control to end the reclined state even when autonomous driving at autonomous driving level 4 or higher is continued. For example, when the driver's smartphone is connected to the communication bus 90 (in-vehicle network), the reclining control unit 424 controls the reclined state of driver seat to be terminated when the smartphone receives an incoming call or an email. The control for terminating reclined state in response to an incoming call or email may be set in automatic manner so as not to be performed by a user operation. When it is necessary to operate the operation unit 33, the reclining control unit 424 terminates the reclined state of driver seat and controls the driver seat back to be raised to a position where the operation unit 33 can be operated by the driver. When an approach of emergency vehicle is detected by the periphery monitoring sensor 60, the reclining control unit 424 terminates the reclined state and performs angle control to raise the driver seat back to the extent that the emergency vehicle can be seen.

### Summary of First Embodiment

In the first embodiment described above, when the back of driver seat is in a reclined state and the autonomous driving is switched to the autonomous driving level 3 or lower (S2, S3: YES), the reclining control unit 424 terminates the reclined state of driver seat back (S7, S10, S13, S15). The reclining control unit 424 controls the notification unit 30 to output a notification associated with termination of the reclined state (S6, S10, S12, S15). By outputting the notification associated with the termination of reclined state, it is possible to prevent the driver from feeling uncomfortable due to the automatic termination of reclined state.

When terminating the reclined state, the reclining control unit 424 determines the execution order of angle control of the driver seat back for terminating the reclined state and notification control by the notification unit 30, depending on the consciousness state of driver. With this configuration, the driver can easily adapt to the level of autonomous driving after the level is lowered, and it is possible to ensure the convenience of nap enabled autonomous driving.

For example, when terminating the reclined state, the reclining control unit 424 simultaneously executes the angle control of driver seat back and the output control by the notification unit 30 in response to a simultaneous control condition being satisfied (S10). The simultaneous control condition is that (i) the autonomous driving level acquisition unit 422 has acquired that the autonomous driving level will immediately switch to autonomous driving level 3 or lower (S4: YES), (ii) the driver is in a sleep state (S5: YES), and (iii) the sequential control condition (S8, S9) is not satisfied.

When the driver is in a sleep state, termination of reclined state and the emergency notification may be executed simultaneously. Since the driver can be woken up by terminating the reclined state, the driver can more easily recognize the emergency notification compared with a case where the notification unit 30 only outputs the emergency notification.

When the driver is in sleep state (S5: YES) and the sequential control condition (S8, S9) that the passenger (non-infant) is in awake state is satisfied, the emergency notification is output (S6). Then, angle control of driver seat back is started (S7). This is because when the passenger is in awake state, the passenger may recognize the emergency notification and wake up the driver. When the reclined state is automatically terminated in a case where the passenger wakes the driver up, the driver needs to understand or be aware of multiple situations at the same time, and may feel confused. Thus, when the sequential control condition (S8, S9) including that the passenger (non-infant) is in awake state is satisfied, S6 and S7 are successively executed.

The sequential control conditions includes that the passenger other than driver is awake (S8: YES) and that the awake passenger other than driver is not an infant (S9: NO). This is because when the awake passenger is an infant, the passenger cannot wake up the driver.

When the autonomous driving level is switched to autonomous driving level 3 or lower (S2, S3: YES) and the driver is awake (S5, S11: YES), the reclining control unit 424 first controls the notification output from the notification unit 30 (S6, S12). Then, the angle control of driver seat back is started (S7, S13). Even if the driver seat is in a reclined state, if the driver is awake, a warning will be given and the driver will be able to assume a driving position. Thus, necessity of terminating reclined state quickly is lowered. By providing the notification first, even when the reclined state is automatically terminated after the notification, the driver can understand the reason why the reclined state is going to be terminated. Therefore, it is possible to prevent the driver from being confused when the reclined state is automatically terminated.

The reclining control unit 424 terminates the reclined state (S14) under the condition that the switching of autonomous driving level is not emergency (S4: NO) and the driver is in sleep state (S11: sleep). Then, notification is output to notify termination of autonomous driving level 4 within a short period (S15). By terminating the reclined state, the driver can become awake. Therefore, by terminating the reclined state first, it becomes easier for the driver to recognize the notification.

When terminating the reclined state, if the autonomous driving level switching is determined to be not emergent (S4: NO) and the driver is in awake state (S11: awake), the reclining control unit 424 notifies termination of autonomous driving level 4 within a short period (S12). Then, the reclined state is terminated (S13). By notifying the driver in advance and then automatically terminating the reclined state, it is possible to reduce the discomfort felt by the driver.

In the above embodiment, the reclining control unit 424 changes the maximum control angle of driver seat back depending on the consciousness state of driver when terminating the reclined state (S7, S10, S13, S15). By changing the maximum control angle of driver seat back depending on the consciousness state of driver, the driver can quickly adapt to the autonomous driving level after switch, regardless of the consciousness state of driver. Thus, it is possible to ensure the convenience of nap enabled autonomous driving.

For example, when the autonomous driving level will switch to level 3 or lower within a short period (S2: YES, S4: NO) and the driver is in sleep state (S11: sleep), the reclining control unit 424 executes the forward via termination control (S14). In the forward via termination control, the seat back is first inclined forward to have a forward inclined angle. When the back of driver seat is set to the forward inclined angle, the driver is forced to be in an uncomfortable position, which tends to wake the driver up.

When the autonomous driving level acquisition unit 422 has acquired that the autonomous driving level immediately switches to autonomous driving level 3 or lower (S4: YES), the reclining control unit 424 controls the angle of driver seat back to the driving state angle (S7, S10) regardless of the consciousness state of driver. This configuration can help the driver to quickly have a driving posture.

When the autonomous driving level acquisition unit 422 has acquired that the autonomous driving level will immediately switch to autonomous driving level 3 or lower (S4: YES), the reclining control unit 424 adjusts the angle of passenger seat back to the standard angle (S7, S10). As a result, the passenger can be quickly placed in a safe position such that the passenger can be prepared for the possibility of a collision or sudden braking of vehicle 6.

The reclining control unit 424 controls the angle change speed of the angle of driver back seat to be faster (S7, S10) when switching of autonomous driving level is required as emergency (S4: YES), compared with a case where switching of the autonomous driving level is not required as emergency (S4: NO). Thus, the driver can be quickly forced to tack a posture suitable for driving. The change speed of angle of driver seat back is not set to high speed when switching of the autonomous driving level is not emergent (S4: NO), it is possible to prevent the driver from being unnecessarily surprised.

### Second Embodiment

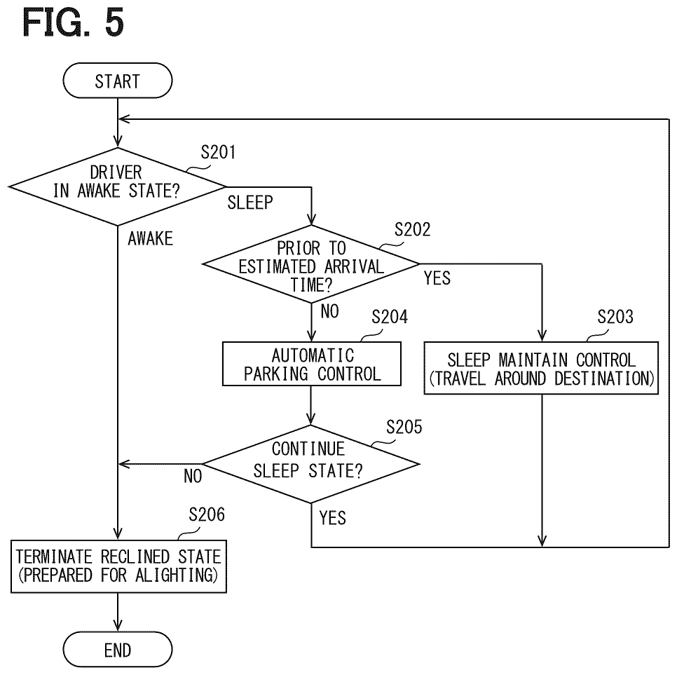

In the second embodiment, suppose that use of autonomous driving level 4 is permitted on local road. The autonomous driving ECU 42 can control the vehicle 6 to arrive at a destination parking lot set by the driver by continuing the autonomous driving at the autonomous driving level 4. When the autonomous driving level 4 can be continued and the driver seat is in the reclined state, the autonomous driving ECU 42 executes the process shown in FIG. 5 (hereinafter referred to as state control process) based on the approach to the destination.

The state control process includes a reclining control executed when the vehicles arrives a position near the destination and wakes up the driver in a planned manner not in emergency. The autonomous driving ECU 42 may determine approach to the destination when a remaining distance to the destination becomes less than a predetermined distance or when a remaining period until the vehicle reaches the destination becomes less than a predetermined period. In response to determining approach to the destination, the state control process shown in FIG. 5 is started.

In S201, the driver condition acquisition unit 423 determines whether the driver is in awake state. When the driver is in awake state, the process proceeds to S206. When the driver is in sleep state, the process proceeds to S202.

In S202, the autonomous driving control execution unit 421 compares the estimated arrival time notified to the driver in advance with the current time, and determines whether the current time is prior to the estimated arrival time. The estimated arrival time is a time presented to the driver when the driver sets a destination, and is a time calculated by the navigation device 75 on the edge side or calculated by a route search server on the cloud side. In the determination of S202, when the current time is prior to the estimated arrival time, the process proceeds to S203. When the current time is after the estimated arrival time, the process proceeds to S204.

In S203, since the driver is in sleep state (S201: Sleep) and the current time is prior to the estimated arrival time (S202: YES), the autonomous driving control execution unit 421 executes a sleep maintenance control to maintain the sleep state of driver. As the sleep maintenance control, the autonomous driving control execution unit 421 may perform autonomous driving to travel around the destination at the autonomous driving level 4. The autonomous driving control execution unit 421 performs the autonomous driving control to travel around the destination until the driver wakes up (S201: Wake up) or until the estimated arrival time (S202: NO).

In S204, since the estimated arrival time has passed (S202: NO), the autonomous driving control execution unit 421 executes automatic parking control to park the vehicle 6 in the destination parking lot. In this case, the driver condition acquisition unit 423 further acquires sleep related information related to the sleep state of driver in S205. The driver condition acquisition unit 423 acquires, from the driver condition determination unit 21, information such as the sleep duration of driver, fatigue level, and whether the driver is in a REM sleep state, as the sleep related information.

The reclining control unit 424 determines whether to perform the angle control of driver seat back to terminate the reclined state, based on the sleep related information acquired by the driver condition acquisition unit 423. For example, when (i) the sleep duration is shorter than a predetermined period, (ii) the fatigue level exceeds a predetermined level, or (iii) the driver is in a non-REM sleep state, the reclining control unit 424 determines to continue the sleep state (S205: YES). In response to determining continuation of sleep state, the termination of the reclined state is suspended and the process returns to S201. When (i) the sleep duration exceeds the predetermined period, (ii) the fatigue level is below the predetermined level, and the driver is in a REM sleep state, the reclining control unit 424 determines to wake up the driver (S205: NO). In response to determining wake up of the driver, the process proceeds to S206.

In S206, the reclining control unit 424 terminates the reclined state of driver seat. When the passenger seat is in the reclined state as the driver seat, the reclining control unit 424 also terminates the reclined state of passenger seat. The reclining control unit 424 wakes up the driver and the passenger and performs the reclining control such that the driver and the passenger get to be prepared for getting off the vehicle. In S206, the change speed of the angle of seat back during termination of the reclined state may be set to low speed. The slide positions of the driver seat and passenger seat may be moved rearward from the positions set during driving (travelling) state. In S206, the notification unit 30 may notify arrival at the destination.

In the above-described state control process, even when the driver is in awake state, if the passenger is still in sleep state, the reclining control for preparation for getting off the vehicle may be suspended until the passenger wakes up. In this case as well, the autonomous driving control execution unit 421 performs the autonomous driving to travel around the destination until the estimated arrival time is reached.

### Summary of Second Embodiment

The second embodiment described above also provides the same effects as the first embodiment. In the second embodiment, when the vehicle 6 approaches the destination while maintaining the nap enabled autonomous driving level and the driver is in sleep state, the angle control of driver seat back (S206) is suspended. This allows the driver to maintain the sleep state. According to this configuration, the convenience of nap enabled autonomous driving can be improved.

When the driver is in sleep state, the autonomous driving control execution unit 421 controls the vehicle to travel around the destination by performing autonomous driving at autonomous driving level 4 (S203). According to the driving control that delays the time of parking in this way, the sleep states of the driver and passenger can be prevented from being viewed by other people. Thus, crimes can be prevented from being occurred. When the passenger is an infant, the sleeping infant is less likely to be woken up by the behavior and vibration of the vehicle 6 heading toward the parking lot. When only one of the driver or the passenger is in sleep state, traveling around the destination can allow the awake driver or passenger to see the scenery around the destination.

When the current time is prior to the estimated arrival time notified to the driver in advance (S202: YES), the autonomous driving control execution unit 421 executes autonomous driving to travel around the destination. When the current time reaches the estimated arrival time, traveling around the destination may be stopped. Therefore, a situation in which arrival at the destination is delayed due to traveling around the destination can be avoided.

When the driver is in sleep state, the driver condition acquisition unit 423 further acquires sleep related information related to the sleep state of driver. When the vehicle 6 is parked at the destination and the driver is still in sleep state, the reclining control unit 424 determines whether to perform angle control of the driver seat back to terminate the reclined state based on the sleep related information. According to this configuration, it is possible to avoid a situation in which execution of reclining control to forcibly wake up the driver can be avoided when the driver is in a state difficult to wake up. As a result, the convenience of nap enabled autonomous driving can be further improved.

### Third Embodiment

Similar to the second embodiment, the autonomous driving ECU 42 of the third embodiment is capable of performing autonomous driving at the autonomous driving level 4 on a local road, and can control the vehicle 6 to arrive at the destination by continuing the autonomous driving. In this embodiment, suppose that the autonomous driving ECU 42 has an automatic valet parking function, and can perform automatic valet parking at a destination parking lot without a passenger on board.

The driver can park the vehicle at a designated boarding and alighting area, and then gets off the vehicle. Then, the vehicle can perform automatic valet parking with the autonomous driving ECU 42 in response to an instruction made by the driver. The autonomous driving ECU 42 receives designation of a driving route and a parking location from the parking lot control center, and automatically drives the vehicle 6 at low speed to the parking location in accordance with the instruction. The driver can call the vehicle 6 from a designated boarding and alighting area using a mobile terminal. Upon receiving a request from the driver, the autonomous driving ECU 42 controls the vehicle 6 to automatically travel at a low speed according to instruction from the control center, and stops the vehicle at the boarding and alighting area.

### (Reclining Control Executed at Arrival Time)

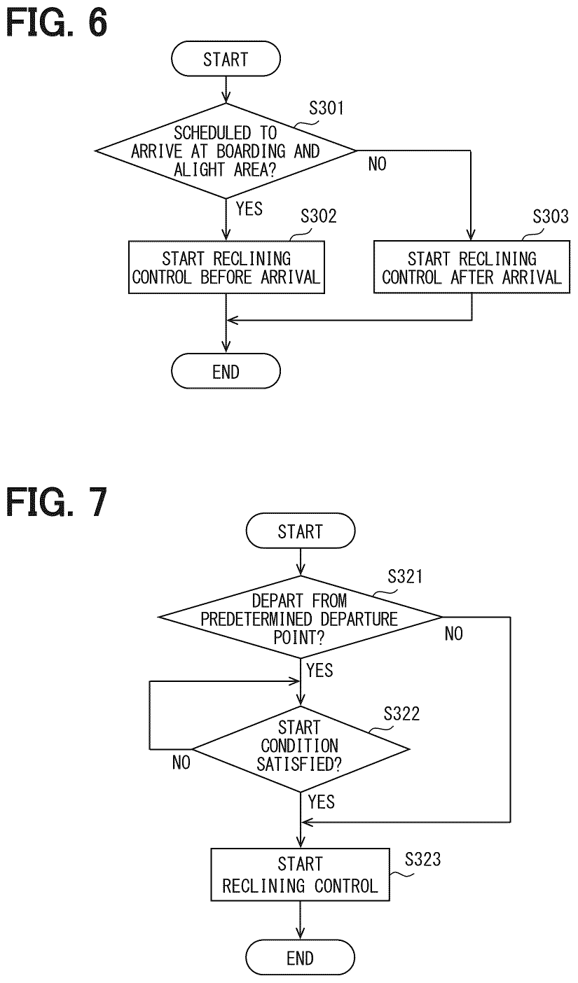

When the autonomous driving level 4 can be continued and the driver seat or passenger seat is in the reclined state, the autonomous driving ECU 42 executes the process shown in FIG. 6 (hereinafter referred to as an arrival process) based on the approach to the destination. In the arrival process shown in FIG. 6, the control details for terminating reclined state in autonomous driving to the boarding and alighting area are set different from the control details for terminating reclined state in autonomous driving to the parking lot.

In S301 of the arrival process, the autonomous driving control execution unit 421 determines the type of destination. Based on the information acquired from the navigation device 75, the autonomous driving control execution unit 421 determines whether the vehicle 6 is scheduled to arrive at the boarding and alighting area. When the vehicle arrives at the boarding and alighting area, the process proceeds to S302. When the vehicle arrives at the parking lot instead of the boarding and alighting area, the process proceeds to S303. When the destination is a road adjacent to the destination, the process proceeds to S302.

In S302, the reclining control unit 424 starts angle control of passenger seat back and driver seat back to terminate the reclined states of driver seat and passenger seat before the vehicle arrives at the boarding and alighting area by performing the autonomous driving. The reclining control unit 424 wakes up the driver and the passenger before arriving at the boarding and alighting area, and performs the reclining control to make the driver or passenger be prepared for getting off. After the driver or passenger gets off the vehicle, the vehicle 6 moves to a parking location using the automatic valet parking function.

In S303, the reclining control unit 424 starts angle control of passenger seat back and driver seat back to terminate the reclined states of driver seat and passenger seat after the vehicle arrives at the parking lot by performing the autonomous driving. As described above, after the vehicle 6 has stopped at the parking lot, the reclining control unit 424 wakes up the driver and the passenger and performs reclining control to make the driver or passenger be prepared for getting off.

### (Reclining Control Executed at Departure Time)

The autonomous driving ECU 42 executes the process shown in FIG. 7 (hereinafter referred to as start process) when the vehicle can immediately start the autonomous driving at autonomous driving level 4 from a boarding and alighting area or a parking lot. In the start process shown in FIG. 7, an immediate start of control for reclining the driver seat or passenger seat is temporarily suspended.

In S321 of the start process, the autonomous driving control execution unit 421 acquires the type of departure point. The autonomous driving control execution unit 421 determines whether the vehicle 6 starts from a predetermined departure point based on information acquired from the navigation device 75. The predetermined departure point is a place where there are people around, such as a boarding and alighting area or a parking lot. When the vehicle is determined to start from the predetermined departure point, the process proceeds to S322. When the vehicle is determined to start from a location that does not correspond to the predetermined departure point, for example, from a state where the vehicle is parked on the road shoulder, the process proceeds to S323.

In S322, the reclining control unit 424 determines whether the start condition of reclining control is satisfied. For example, when the vehicle 6 moves to a road around where there is few people, or when the travel speed of the vehicle 6 exceeds a threshold value (for example, 30 km/h), the reclining control unit 424 determines that the start condition of reclining control is satisfied. When the vehicle is traveling at low speed near a boarding and alighting area or a parking lot (S322: NO), the reclining control is in a standby state.

When the vehicle starts from a location other than the predetermined departure point (S321: NO) or when the start condition is satisfied (S322: YES), the reclining control unit 424 starts the reclining control to recline the driver seat back toward rear direction of vehicle in S323. When a passenger other than driver is on board, the reclining control unit 424 also starts reclining control to recline the back of passenger seat toward rear direction of vehicle.

### Summary of Third Embodiment

The third embodiment described above also provides the same effects as the first embodiment. In the third embodiment, when the vehicle 6 can continue the autonomous driving level 4 until arrival at the destination, the type of the destination is specified (S301). The type of destination includes at least one of (i) the boarding and alighting area or (ii) the parking lot. Then, the reclining control unit 424 changes details of the angle control of driver seat back to terminate the reclined state depending on whether the destination is the boarding and alighting area or the parking lot (S302, S303). According to this configuration, reclining control can be performed suitable for the place where the passenger or driver gets off the vehicle.

When the vehicle 6 heads to the boarding and alighting area with the autonomous driving level 4 being maintained, the angle control of driver seat back is started before arriving at the boarding and alighting area (S302). When the vehicle 6 heads to the parking lot with the autonomous driving level 4 being maintained, the angle control of driver seat back is started after arriving at the parking lot (S303). Usually, an existence probability of people is higher in a boarding and alighting area compared with a parking lot. Thus, the sleep state can be more easily seen by other people in the boarding and alighting area. Therefore, by terminating the reclined state before arriving at the boarding and alighting area, the possibility that the sleep state is seen by other people can be avoided. When the driver arrives at the boarding and alighting area in awake state, crime prevention can also be improved.

When the vehicle 6 starts traveling from the boarding and alighting area or the parking lot with the autonomous driving level 4 being maintained, the back of driver seat is set to the reclined state under a condition that the vehicle 6 has moved to a predetermined location or has reached a predetermined speed or higher (S321 to S323). That is, the reclining control unit 424 does not recline the driver seat until the vehicle 6 moves to a road around where few people exist and see the vehicle. Therefore, it is possible to prevent the user from feeling embarrassed due to having his or her sleep state seen by other people.

### Fourth Embodiment

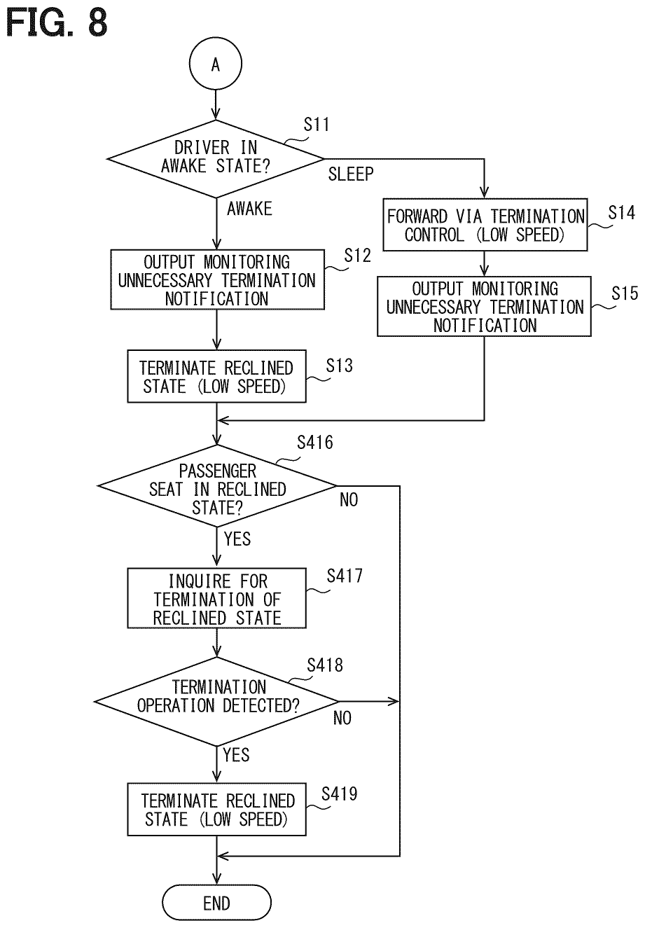

The autonomous driving ECU 42 according to the fourth embodiment performs process different from that of the first embodiment when the switch to the autonomous driving level is determined to be not emergent (S4: NO, see FIG. 3). When the determination result in S4 is NO, the autonomous driving ECU 42 starts the process shown in FIG. 8 (hereinafter referred to as planned awakening process). In the planned awakening process, reclining control is performed to wake up the driver with a higher priority than other passengers.

In S11 to S15 of the planned awakening process, the reclining control unit 424 performs the process similar to the process executed in the first embodiment. The reclining control unit 424 changes the control order depending on whether the driver is in awake state or not, and performs the monitoring unnecessary termination notification and the angle control to terminate the reclined state.

In S416, the process acquires the angle of passenger seat back from the passenger seat angle adjustment unit 12, and determines whether the passenger seat is in reclined state. When the determination result in S416 is YES, the process proceeds to S417. When the determination result in S416 is NO, the planned awakening processes is ended.

In S417, the process makes an inquiry to the driver on the display 32 for whether to terminate the reclined state of the passenger seat. In S418, the reclining control unit 424 determines whether a termination operation is input to the operation unit 33 by the driver. The termination operation is an operation for instructing termination of reclined state of the passenger seat. The termination operation may be a touch operation of touching a button icon displayed on the display 32.

When the determination result in S418 is YES, the process proceeds to S419 and the reclining control unit 424 performs angle control to terminate the reclined state of the passenger seat in S419. When the determination result in S418 is NO, the planned awakening processes is ended.

### Summary of Fourth Embodiment

The fourth embodiment described above also provides the same effects as the first embodiment. In the fourth embodiment, when terminating the reclined state, the angle control of driver seat back (S13, S14) is given higher priority than the angle control of passenger seat back (S419). The reclining control unit 424 controls the driver seat back to be raised with higher priority than the control of passenger seat back. Therefore, the driver can recognize the monitoring unnecessary termination notification and starts monitoring the periphery area of vehicle without being interrupted by the passenger.

The reclining control unit 424 starts the angle control of passenger seat back to terminate the reclined state in response to the input of termination operation made by the driver (S418, S419). Since the reclining control of passenger seat is determined by the driver's operation, it is possible to avoid forcibly wake up the passenger by the reclining control.

### Fifth Embodiment

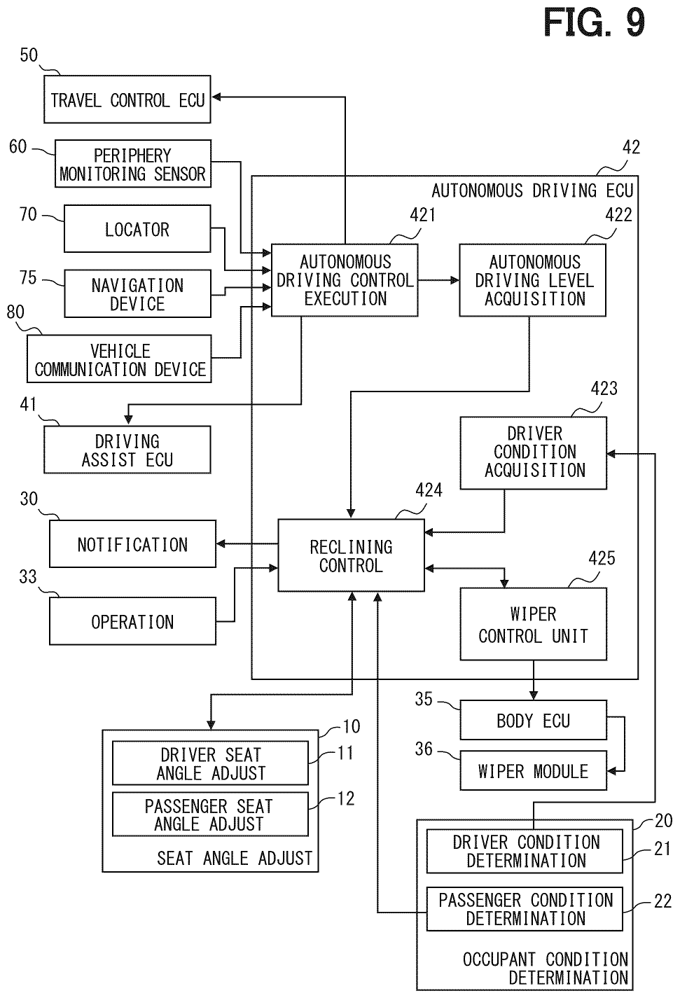

The autonomous driving ECU 42 of the fifth embodiment includes a wiper control unit 425 shown in FIG. 9 in addition to the functional units 421 to 424 of the first embodiment shown in FIG. 1. The wiper control unit 425 is implemented by the processor 43 by executing a program stored in a memory. The wiper control unit 425 can control the operation of wiper module 36 mounted on the vehicle 6 in cooperation with a body ECU 35.

The body ECU 35 is an ECU that integrally controls vehicle-mounted devices included in a body system mounted to the vehicle 6. The body ECU 35 outputs a signal to the wiper module 36 to start and stop the wiper operation. The wiper module 36 includes a controller and a motor. The wiper module 36 changes the wiping timing and wiping speed of the front and rear wipers mounted on the vehicle 6 according to command signals output from the body ECU 35.

### (Wiper Operation Restriction Process and Restriction Cancel Process)

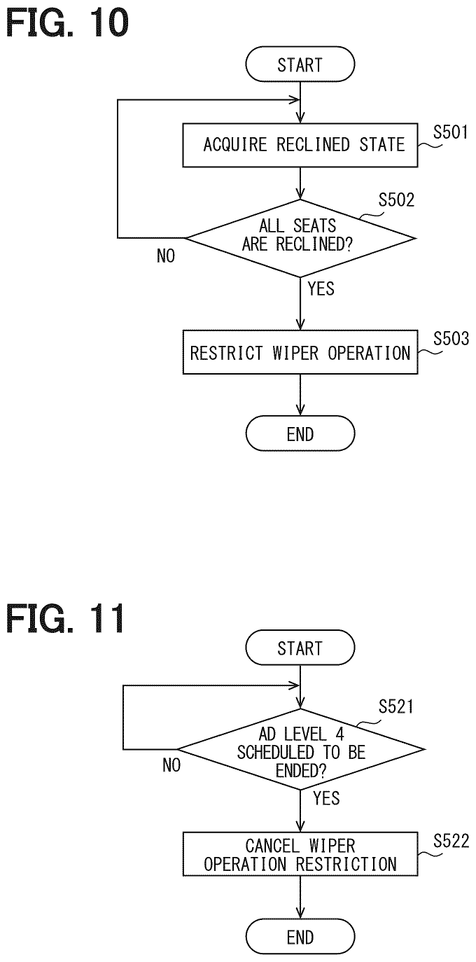

The autonomous driving ECU 42 executes the process shown in FIG. 10 (hereinafter referred to as operation restriction process) when the autonomous driving control execution unit 421 starts autonomous driving at the autonomous driving level 4. In S501 of the operation restriction process shown in FIG. 10, the driver condition acquisition unit 423 and the reclining control unit 424 acquire the reclined states of driver seat and passenger seat. In S502, the reclining control unit 424 determines whether all seats including the driver seat are in reclined states. When the determination result in S502 is NO, the process repeats S501 and S502. When both of the back of driver seat and the back of passenger seat are in the reclined states and the determination result in S502 is YES, the wiper control unit 425 restricts the operation of the wiper in S503.

When the wiper control unit 425 activates the operation restriction, the wiper control unit 425 basically stops wiping operation by the wiper. The wiper control unit 425 may increase the wiping interval or decrease the wiping speed as the operation restriction. When detection operation executed by the camera unit 61 is obstructed by raindrops, the wiper control unit 425 may operate the wipers successively so that the forward recognition function of the camera unit 61 is not impaired by the raindrops.

The autonomous driving ECU 42 executes the process shown in FIG. 11 (hereinafter referred to as a restriction cancel process) based on the activation of wiper operation restriction. In S521 of the restriction cancel process shown in FIG. 11, the autonomous driving control execution unit 421 determines whether the autonomous driving level 4 is scheduled to be ended. When the emergency becomes high, when the vehicle approaches to a driving switch point, or when a decrease of autonomous driving level is predicted, the autonomous driving control execution unit 421 determines that the autonomous driving level 4 is scheduled to be ended. In other words, it is determined that the autonomous driving level 3 is planned to be executed.

When the determination result in S521 is NO, the process repeats determination in S521. When the determination result in S521 is YES, the wiper control unit 425 eases the wiper operation restriction in S522. The wiper control unit 425 may cancel all limitations set in the operation restrictions and control the wiper to start normal operation. The wiper control unit may gradually cancel limitations set in the operation restrictions and gradually increase the wiping frequency and operation speed of wiper.

### Summary of Fifth Embodiment

The fifth embodiment described above also provides the same effects as the first embodiment. In the fifth embodiment, the vehicle 6 is equipped with the passenger condition determination unit 22, which determines the consciousness state of passenger, and the passenger seat angle adjustment unit 12, which adjusts the angle of passenger seat back. When both the back of driver seat and the back of passenger seat are in the reclined states (S502: YES), the wiper control unit 425 restricts the operation of wiper mounted on the vehicle 6 (S503). With this configuration, when all of the seats where passengers are seated are in the reclined states and there is a possibility that all of the passengers and driver are in sleep states, the operation of wiper is restricted. As a result, it is possible to avoid the operating noise of wiper from disturbing the sleep states of passenger and driver.

When the autonomous driving level is scheduled to be decreased to a level lower than autonomous driving level 4 (S521: YES), the wiper control unit 425 eases the restriction applied to wiper operation (S522). As described above, the wiper operation can be restarted at a timing when the driver needs to monitor the periphery area of the vehicle. As a result, the driver can restart monitoring of periphery area in a state where the visibility is maintained.

Although embodiments of the present disclosure have been described above, the present disclosure is not limited to the above-described embodiments, and the following modifications are also included in the present disclosure. Further, various modifications can be made without departing from the spirit of the present disclosure.

### (First Modification)

In the embodiments described above, the autonomous driving ECU 42 functions as the autonomous driving level acquisition unit 422, the driver condition acquisition unit 423, and the reclining control unit 424. Alternatively, the autonomous driving level acquisition unit 422, the driver condition acquisition unit 423, and the reclining control unit 424 may be executed by an ECU different from the autonomous driving ECU 42.

### (Second Modification)

The driver condition determination unit 21 and the passenger condition determination unit 22 may detect the conditions of the driver and passenger using biological information detection device other than the camera instead of or in addition to the camera. Examples of biological information detection device other than camera may include biological information detection device that detects body temperature, heartbeat, or pulse.

### (Third Modification)

The execution order of S2 and S3 may be reversed.

### (Fourth Modification)

In the above embodiments, when an emergency occurs (S4: YES), the back of driver seat is immediately changed to the driving state angle (S7, S10), regardless of the consciousness state of driver. Alternatively, when an emergency is detected under the driver is in sleep state, the forward via termination control may be executed. This is because it is better to wake up the driver quickly in some cases. For example, when the detected emergency has low risk of collision and the driver is in sleep state, the forward via termination control may be executed.

In response to detection of emergency, only the reclined state of driver seat back may be terminated without terminating the reclined state of other passenger seats in S7 and S10. This is because, when the detected emergency has low risk of collision, the passenger seat may continue the reclined states in some cases.

### (Fifth Modification)

In the embodiment described above, each function related to the vehicle control device for driver implemented by the autonomous driving ECU 42 may be implemented by a vehicle-mounted ECU different from the autonomous driving ECU 42. As an example, partial function of the vehicle control device for driver may be implemented in a human machine interface (HMI) ECU that integrally controls the user interface installed in the vehicle 6. In such a configuration, the HMI ECU or a system including the autonomous driving ECU and the HMI-ECU corresponds to the vehicle control device for driver disclosed in the present disclosure.

### (Sixth Modification)

The form of a storage medium (a non-transitory tangible computer readable medium) that stores various programs and the like may also be appropriately changed. The storage medium is not limited to the configuration provided on the circuit board, and may be provided in the form of a memory card or the like, inserted into a slot portion, and electrically connected to a control circuit such as an autonomous driving ECU or an HMI ECU. The storage medium may include an optical disk which forms a source of programs to be copied or to be distributed into the autonomous driving ECU or the HMI ECU, or a hard disk drive therefor.

### (Seventh Modification)

The driving assist ECU 41, the autonomous driving ECU 42, and the travel control ECU 50 correspond to a control unit described in the following description. The control unit and the method thereof described in the present disclosure may be implemented by a special purpose computer, which includes a processor programmed to execute one or more functions performed by computer programs. Alternatively, the device and the method thereof according to the present disclosure may be implemented by a dedicated hardware logic circuit. Alternatively, the device and the method thereof according to the present disclosure may be implemented by one or more dedicated computers configured with a combination of a processor that executes a computer program and one or more hardware logic circuits. The computer program may also be stored in a computer-readable and non-transitory tangible storage medium as instructions to be executed by a computer.

What is claimed is:

1. A vehicle control device for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back; and
a driver condition determination unit determining whether a consciousness state of the driver is an awake state or a sleep state,
the vehicle control device for driver comprising:
an autonomous driving level acquisition unit acquiring a currently executing autonomous driving level that is currently being executed by the autonomous driving system and a scheduled autonomous driving level that is scheduled to be executed;
a driver condition acquisition unit acquiring the consciousness state of the driver from the driver condition determination unit; and
a reclining control unit, in response to the autonomous driving level acquisition unit acquiring that the autonomous driving level is to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle,
wherein
the autonomous driving level acquisition unit acquires a type of a destination when the vehicle can reach the destination with the nap enabled autonomous driving level being maintained,
the type of the destination includes at least one of (i) a boarding and alighting area or (ii) a parking lot,
in the termination of the reclined state, the reclining control unit determines, according to the consciousness state of the driver, an execution order of an angle control, which controls the angle of the driver seat back to terminate the reclined state, and an output control, which outputs the notification related to the termination of the reclined state, and
the reclining control unit changes details of the angle control, which controls the angle of the driver seat back to terminate the reclined state, when the destination is set to the boarding and alighting area from when the destination is set to the parking lot.

2. The vehicle control device for driver according to claim 1, wherein,
when the vehicle travels toward the boarding and alighting area with the nap enabled autonomous driving level being maintained, the reclining control unit starts the angle control of the driver seat back before the vehicle arrives at the boarding and alighting area, and
when the vehicle travels toward the parking lot with the nap enabled autonomous driving level being maintained, the reclining control unit starts the angle control of the driver seat back after the vehicle arrives at the parking lot.

3. The vehicle control device for driver according to claim 1, wherein,
when the vehicle departures from (i) the boarding and alighting area or (ii) the parking lot at the nap enabled autonomous driving level, the reclining control unit controls the driver seat back to the reclined state after the vehicle travels to a predetermined location or the vehicle reaches a predetermined speed or higher.

4. The vehicle control device for driver according to claim 1, wherein,
in the termination of the reclined state, the reclining control unit simultaneously executes the angle control of the driver seat back and the output control via the notification unit when (i) the autonomous driving level acquisition unit acquires that the autonomous driving level is required to be immediately switched to the autonomous driving level lower than the nap enabled autonomous driving level and (ii) a simultaneous control condition is satisfied in response that the consciousness state of the driver is the sleep state.

5. The vehicle control device for driver according to claim 4, wherein
the vehicle is equipped with a passenger condition determination unit that determines whether a consciousness state of a passenger other than the driver is an awake state or a sleep state, and
in the termination of the reclined state, the reclining control unit executes the output control via the notification unit first and then executes the angle control of the driver seat back when (i) the autonomous driving level acquisition unit acquires that the autonomous driving level is required to be immediately switched to the autonomous driving level lower than the nap enabled autonomous driving level and (ii) a sequential control condition is satisfied in response that the consciousness state of the driver is the sleep state and the consciousness state of the passenger is the awake state.

6. A vehicle control device for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back;
a driver condition determination unit determining whether a consciousness state of the driver is an awake state or a sleep state; and
a passenger condition determination unit determining whether a consciousness state of a passenger other than the driver is an awake state or a sleep state,
the vehicle control device for driver comprising:
an autonomous driving level acquisition unit acquiring a currently executing autonomous driving level that is currently being executed by the autonomous driving system and a scheduled autonomous driving level that is scheduled to be executed;
a driver condition acquisition unit acquiring the consciousness state of the driver from the driver condition determination unit; and
a reclining control unit, in response to the autonomous driving level acquisition unit acquiring that the autonomous driving level is to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle,
wherein,
in the termination of the reclined state, the reclining control unit determines, according to the consciousness state of the driver, an execution order of an angle control, which controls the angle of the driver seat back to terminate the reclined state, and an output control, which outputs the notification related to the termination of the reclined state via the notification unit,
the reclining control unit simultaneously executes the angle control of the driver seat back and the output control via the notification unit when (i) the autonomous driving level acquisition unit acquires that the autonomous driving level is required to be immediately switched to the autonomous driving level lower than the nap enabled autonomous driving level and (ii) a simultaneous control condition is satisfied in response that the consciousness state of the driver is the sleep state, and
the reclining control unit executes the output control via the notification unit first and then executes the angle control of the driver seat back when (i) the autonomous driving level acquisition unit acquires that the autonomous driving level is required to be immediately switched to the autonomous driving level lower than the nap enabled autonomous driving level and (ii) a sequential control condition is satisfied in response that the consciousness state of the driver is the sleep state and the consciousness state of the passenger is the awake state.

7. The vehicle control device for driver according to claim 5, wherein
the sequential control condition is satisfied when (i) the consciousness state of the driver is the sleep state and (ii) the passenger, who is in the awake state, is not an infant.

8. The vehicle control device for driver according to claim 1, wherein,
in the termination of the reclined state, the reclining control unit executes the output control via the notification unit first and then executes the angle control of the driver seat back when (i) the autonomous driving level acquisition unit acquires that the autonomous driving level is required to be immediately switched to the autonomous driving level lower than the nap enabled autonomous driving level and (ii) the consciousness state of the driver is the awake state.

9. The vehicle control device for driver according to claim 1, wherein,
in the termination of the reclined state, the reclining control unit terminates the reclined state first and then outputs, via the notification unit, the notification indicating a scheduled termination of the nap enabled autonomous driving level within a predetermined period when (i) the autonomous driving level acquisition unit acquires that the autonomous driving level is scheduled to be switched from the nap enabled autonomous driving level to a level lower than the nap enabled autonomous driving level within the predetermined period and (ii) the consciousness state of the driver is the sleep state.

10. The vehicle control device for driver according to claim 1, wherein,
in the termination of the reclined state, the reclining control unit outputs, via the notification unit, the notification indicating a scheduled termination of the nap enabled autonomous driving level within a predetermined period first and then terminates the reclined state when (i) the autonomous driving level acquisition unit acquires that the autonomous driving level is scheduled to be switched from the nap enabled autonomous driving level to a level lower than the nap enabled autonomous driving level within the predetermined period and (ii) the consciousness state of the driver is the awake state.

11. The vehicle control device for driver according to claim 1, wherein,
in the termination of the reclined state, the reclining control unit:
determines, according to the consciousness state of the driver, the execution order of the angle control, which controls the angle of the driver seat back, and the output control, which outputs the notification via the notification unit; and
changes a maximum standing angle of the driver seat back according to the consciousness state of the driver.

12. The vehicle control device for driver according to claim 1, further comprising
a passenger seat angle adjustment unit adjusting an angle of a passenger seat back,
wherein the reclining control unit performs the angle control of the driver seat back with a higher priority than an angle control of the passenger seat back when terminating the reclined state.

13. The vehicle control device for driver according to claim 12, wherein
the reclining control unit starts the angle control of the passenger seat back to terminate the reclined state of the passenger seat back based on a termination operation input by the driver.

14. The vehicle control device for driver according to claim 1, further comprising
a wiper control unit restricting an operation of a wiper mounted on the vehicle when both of the driver seat back and a passenger seat back are in the reclined states.

15. The vehicle control device for driver according to claim 14, wherein
the wiper control unit eases restriction applied to the operation of the wiper when the autonomous driving level is scheduled to be switched to a level lower than the nap enabled autonomous driving level.

16. A vehicle control method for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back; and
a driver condition determination unit determining whether a consciousness state of the driver is an awake state or a sleep state,
the vehicle control method for driver comprising:
acquiring a currently executing autonomous driving level at which the autonomous driving system is executing the autonomous driving and the autonomous driving level scheduled to be executed;
acquiring the consciousness state of the driver from the driver condition determination unit;
in response to acquiring that the autonomous driving level is required to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle;
acquiring a type of a destination when the vehicle can reach the destination with the nap enabled autonomous driving level being maintained, the type of the destination including at least one of (i) a boarding and alighting area or (ii) a parking lot;
determining, according to the consciousness state of the driver, an execution order of an angle control, which controls the angle of the driver seat back to terminate the reclined state, and an output control, which outputs the notification related to the termination of the reclined state; and
changing details of the angle control, which controls the angle of the driver seat back to terminate the reclined state, when the destination is set to the boarding and alighting area from when the destination is set to the parking lot.

17. A vehicle control method for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back;
a driver condition determination unit determining whether a consciousness state of the driver is an awake state or a sleep state; and
a passenger condition determination unit determining whether a consciousness state of a passenger other than the driver is an awake state or a sleep state,
the vehicle control method for driver comprising:
acquiring a currently executing autonomous driving level at which the autonomous driving system is executing the autonomous driving and the autonomous driving level scheduled to be executed;
acquiring the consciousness state of the driver from the driver condition determination unit;
in response to acquiring that the autonomous driving level is required to be switched from the nap enabled autonomous driving level to the autonomous driving level lower than the nap enabled autonomous driving level in a reclined state of the driver seat back, terminating the reclined state of the driver seat back and outputting a notification related to termination of the reclined state via a notification unit equipped to the vehicle;
in the termination of the reclined state, determining, according to the consciousness state of the driver, an execution order of an angle control, which controls the angle of the driver seat back to terminate the reclined state, and an output control, which outputs the notification related to the termination of the reclined state;
simultaneously executing the angle control of the driver seat back and the output control via the notification unit when (i) acquiring that the autonomous driving level is required to be immediately switched to the autonomous driving level lower than the nap enabled autonomous driving level and (ii) a simultaneous control condition is satisfied in response that the consciousness state of the driver is the sleep state; and
executing the output control via the notification unit first and then executing the angle control of the driver seat back when (i) acquiring that the autonomous driving level is required to be immediately switched to the autonomous driving level lower than the nap enabled autonomous driving level and (ii) a sequential control condition is satisfied in response that the consciousness state of the driver is the sleep state and the consciousness state of the passenger is the awake state.

18. A vehicle control device for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back; and
a driver condition determination unit determining whether a consciousness state of the driver is an awake state or a sleep state,
the vehicle control device for driver comprising:
an autonomous driving level acquisition unit acquiring a currently executing autonomous driving level that is currently being executed by the autonomous driving system and a scheduled autonomous driving level that is scheduled to be executed;
a driver condition acquisition unit acquiring the consciousness state of the driver from the driver condition determination unit; and
a reclining control unit terminating a reclined state of the driver seat back in response to the autonomous driving level acquisition unit acquiring that the autonomous driving level is to be switched from the nap enabled autonomous driving level to the autonomous driving level lower than the nap enabled autonomous driving level in the reclined state of the driver seat back,
wherein, in termination of the reclined state of the driver seat back, the reclining control unit determines different maximum control angles of the driver seat back according to different consciousness states of the driver, and sets the angle of the driver seat back to a forward inclined angle when the consciousness state of the driver is the sleep state.

19. The vehicle control device for driver according to claim 18, wherein,
in the termination of the reclined state, the reclining control unit sets the angle of the driver seat back to the forward inclined angle when (i) the autonomous driving level acquisition unit acquires that the autonomous driving level is scheduled to be switched to the level lower than the nap enabled autonomous driving level within a predetermined period and (ii) the consciousness state of the driver is the sleep state.

20. The vehicle control device for driver according to claim 18, wherein,
in the termination of the reclined state, the reclining control unit sets, regardless of the consciousness state of the driver, the angle of the driver seat back to a driving state angle when the autonomous driving level acquisition unit acquires that the autonomous driving level is required to be immediately switched to the level lower than the nap enabled autonomous driving level.

21. The vehicle control device for driver according to claim 20, further comprising
a passenger seat angle adjustment unit adjusting an angle of a passenger seat back other than the driver seat back,
wherein, in the termination of the reclined state, the reclining control unit sets the angle of the driver seat back to the driving state angle and sets the angle of the passenger seat back to a standard angle when the autonomous driving level acquisition unit acquires that the autonomous driving level is required to be immediately switched to the level lower than the nap enabled autonomous driving level.

22. The vehicle control device for driver according to claim 20, wherein
the reclining control unit changes the angle of the driver seat back at a first change speed to terminate the reclined state when the autonomous driving level acquisition unit acquires that the autonomous driving level is required to be immediately switched to the level lower than the nap enabled autonomous driving level,
the reclining control unit changes the angle of the driver seat back at a second change speed to terminate the reclined state when the autonomous driving level acquisition unit acquires that the autonomous driving level is scheduled to be switched to the level lower than the nap enabled autonomous driving level within a predetermined period, and
the first change speed is set to be higher than the second change speed.

23. A vehicle control method for driver used in a vehicle, the vehicle being equipped with:
an autonomous driving system capable of switching autonomous driving between a nap enabled autonomous driving level, which enables a driver to take a nap, and an autonomous driving level, which requires the driver to immediately get prepared for takeover of driving operation, or lower;
a driver seat angle adjustment unit adjusting an angle of a driver seat back; and
a driver condition determination unit determining whether a consciousness state of the driver is an awake state or a sleep state,
the vehicle control method for driver comprising:
acquiring a currently executing autonomous driving level at which the autonomous driving system is executing the autonomous driving and the autonomous driving level scheduled to be executed;
acquiring the consciousness state of the driver from the driver condition determination unit;
terminating a reclined state of the driver seat back in response to acquiring that the autonomous driving level is to be switched from the nap enabled autonomous driving level to the autonomous driving level lower than the nap enabled autonomous driving level in the reclined state of the driver seat back; and
determining different maximum control angles of the driver seat back according to different consciousness states of the driver and setting the angle of the driver seat back to a forward inclined angle when the consciousness state of the driver is the sleep state in terminating of the reclined state of the driver seat back.

24. A vehicle control device for driver used in a vehicle, the vehicle being equipped with:
an autonomous driving system capable of performing autonomous driving at a nap enabled autonomous driving level that enables a driver to take a nap;
a driver seat angle adjustment unit adjusting an angle of a driver seat back; and
a driver condition determination unit determining whether a consciousness state of the driver is an awake state or a sleep state,
the vehicle control device for driver comprising:
a driver condition acquisition unit acquiring the consciousness state of the driver from the driver condition determination unit; and
a reclining control unit controlling a reclined state of the driver seat back,
wherein,
when the vehicle approaches a destination with the nap enabled autonomous driving level being maintained, the reclining control unit executes an angle control of the driver seat back, which terminates the reclined state, in response that the consciousness state of the driver is the awake state, and
when the vehicle approaches the destination with the nap enabled autonomous driving level being maintained, the reclining control unit suspends the angle control of the driver seat back, which terminates the reclined state, in response that the consciousness state of the driver is the sleep state.

25. The vehicle control device for driver according to claim 24, further comprising
an autonomous driving control execution unit controlling the vehicle to travel around the destination by performing the autonomous driving at the nap enabled autonomous driving level when the consciousness state of the driver is the sleep state.

26. The vehicle control device for driver according to claim 25, wherein
the autonomous driving control execution unit controls the vehicle to travel around the destination by performing the autonomous driving when a current time is earlier than an estimated arrival time notified to the driver in advance.

27. The vehicle control device for driver according to claim 24, wherein
the driver condition acquisition unit acquires sleep related information related to the sleep state of the driver when the driver is in the sleep state, and
when the driver is in the sleep state after the vehicle is parked at the destination, the reclining control unit determines whether to execute the angle control of the driver seat back to terminate the reclined state based on the sleep related information.

28. A vehicle control method for driver used in a vehicle, the vehicle being equipped with:
an autonomous driving system capable of performing autonomous driving at a nap enabled autonomous driving level that enables a driver to take a nap;
a driver seat angle adjustment unit adjusting an angle of a driver seat back; and
a driver condition determination unit determining whether a consciousness state of the driver is an awake state or a sleep state,
the vehicle control method for driver comprising:
acquiring the consciousness state of the driver from the driver condition determination unit;
when the vehicle approaches a destination with the nap enabled autonomous driving level being maintained, executing an angle control of the driver seat back, which terminates a reclined state of the driver seat back, in response that the consciousness state of the driver is the awake state; and
when the vehicle approaches the destination with the nap enabled autonomous driving level being maintained, suspending the angle control of the driver seat back, which terminates the reclined state of the driver seat back, in response that the consciousness state of the driver is the sleep state.
